(19) United States
(12) Patent Application Publication
(10) Pub. No.: US 2017/0170579 A1
(43) Pub. Date: Jun. 15, 2017

(54) BONDING CLAMP

(71) Applicant: Hubbell Incorporated, Shelton, CT (US)

(72) Inventor: Evan Ronald Martin, Derry, NH (US)

(21) Appl. No.: 15/374,079

(22) Filed: Dec. 9, 2016

Related U.S. Application Data
(60) Provisional application No. 62/264,987, filed on Dec. 9, 2015.

(51) Int. Cl. H01R 4/40; H01R 4/26

(52) U.S. Cl. CPC H01R 4/40; H01R 4/26

(57) ABSTRACT

The present disclosure provides descriptions of configurations for bonding clamps used to assembly photovoltaic (PV) arrays, and provide an electrical bond between PV module frames forming part of the PV arrays. The bonding clamp includes an electrically conductive body and at least one electrical bonding member extending from a bottom surface of the body. A first spacer member extends from the electrically conductive body in a direction away from the bottom surface of the body, and a second spacer member extends from the electrically conductive body in a direction away from the bottom surface of the body.

### CROSS REFERENCE TO RELATED APPLICATIONS

The present disclosure is based on and claims benefit from co-pending U.S. Provisional Application Ser. No. 62/264,987 filed Dec. 9, 2015 entitled “Bonding Clamp” the entire contents of which are herein incorporated by reference.

### BACKGROUND

Field

The present disclosure relates generally to bonding clamps, and more particularly to bonding clamps used to secure photovoltaic module frames to rail systems while providing an electrical bonding between the frames.

Description of the Related Art

Photovoltaic arrays are typically composed of a number of photovoltaic modules set within a metallic frame, and a rail system that supports the photovoltaic modules. When installing a photovoltaic array, a number of photovoltaic modules are assembled onto a larger mounting structure, sometimes called rails or racking structures. The metallic frames of the individual photovoltaic modules, and the structural pieces, e.g., the rails, on which the modules mount are generally made out of aluminum, which is typically anodized to resist corrosion. Although the frames of the photovoltaic modules are directly bolted or clamped to the rails, the anodizing insulates the metal structures so that they may not be electrically bonded, unless measures are taken to electrically bond them.

Like other sources of electrical power, to ensure safety, the metal frames of the photovoltaic modules and the metal rails on which they are secured are often required by national or local electrical codes to be electrically bonded. Electrically bonded is used here in the technical sense to mean forming an electrically conductive path between the metal structures to ensure electrical continuity between the metal structures sufficient to safely conduct any electrical current imposed on the metal structures.

To electrically bond the metal structures, a common practice in the industry is to install a separate grounding lug on each piece that is anodized, or a separate grounding washer between anodized metal structures. A grounding lug is attached to the sheet metal frame of the photovoltaic modules with a thread forming stainless steel screw. Since the screw cuts into the aluminum it forms a connection which can maintain an electrical bond over time. However, a common sheet metal thickness is fairly thin, e.g., 0.080 inch, and a common screw size is 10-32 so that the screw therefore only makes connection on about 2½ threads, which provides a marginally acceptable surface contact area in terms of mechanical strength and electrical conductivity. Using separate bonding washers between metal structures provides a larger electrical contact area for an improved electrical bonding connection. However, adding grounding lugs or separate bonding washers increases the cost to install photovoltaic arrays, in terms of supplies, and in terms of labor costs to install the separate bonding components.

### SUMMARY

The present disclosure provides descriptions of embodiments for bonding clamps used to assembly photovoltaic (PV) arrays, and provide an electrical bond between PV module frames forming part of the PV arrays. In one exemplary embodiment, the bonding clamp includes an electrically conductive body having a top side, a bottom side, a fastener receiving member, for example an aperture, for receiving a mounting fastener, and at least one electrical bonding member extending from the bottom surface of the body, a first spacer member extending from the electrically conductive body in a direction away from the bottom surface of the body, and a second spacer member extending from the electrically conductive body in a direction away from the bottom surface of the body. The electrically conductive body can be substantially planar. In another exemplary embodiment, the bonding clamp includes an electrically conductive body having a top side and a bottom side, a first spacer member extending from the electrically conductive body in a direction away from the bottom surface, and a second spacer member extending from the electrically conductive body in a direction away from the bottom surface. The second spacer is aligned with the first spacer member such that the first and second spacers define two portions of the body that include at least one electrical bonding member extending from the bottom surface of the body.

In one exemplary embodiment, the first spacer member extends from one end of the electrically conductive body, and the second spacer member extends from an opposite end of the electrically conductive body. In another exemplary embodiment, the first spacer member extends from the bottom surface of the electrically conductive body, and the second spacer member extends from the bottom surface of the electrically conductive body.

The at least one electrical bonding member may include a plurality of electrical bonding members, wherein each of the plurality of electrical bonding members comprises a single tooth. In some embodiments, the single tooth has a serrated distal end.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a top perspective view of an exemplary embodiment of a bonding clamp according to the present disclosure;

FIG. 2 is a bottom perspective view of the bonding clamp of FIG. 1;

FIG. 3 is a side elevation view of the bonding clamp of FIG. 1;

FIG. 3A is a side elevation view of another exemplary embodiment of the bonding clamp according to the present disclosure;

FIG. 4 is a partial cross-sectional view of the bonding clamp of FIG. 3 taken along line 4-4 and illustrating an electrical bonding member for piercing non-conductive surfaces of metal structures to facilitating an electrical bond between metal surfaces;

FIG. 5 is a partial cross-sectional view of the bonding clamp of FIG. 3 taken along line 4-4, but illustrating another exemplary embodiment of an electrical bonding member for piercing non-conductive surfaces of metal structures to facilitating an electrical bond between metal surfaces;

FIG. 6 is a top perspective view, with the parts separated, of an exemplary embodiment of the bonding clamp of FIG. 1, photovoltaic module frames, and a rail;

FIG. 7 is a top perspective view of the exemplary embodiment of FIG. 6, with the bonding clamp, connecting and bonding photovoltaic module frames to the rail; and

FIG. 8 is a partial cross-sectional view of the bonding clamp of FIG. 3 taken along line 4-4 and a partial cross-sectional view of a photovoltaic module frame, illustrating the electrical bonding member piercing a non-conductive surface of the photovoltaic module frame.

### DETAILED DESCRIPTION

The present disclosure provides descriptions of embodiments for bonding clamps used to assembly photovoltaic (PV) arrays, and provide an electrical bond between PV module frames forming part of the PV arrays. This specification and the accompanying drawings are to be regarded in an illustrative sense rather than a restrictive sense. Various modifications may be made thereto without departing from the spirit and scope of the present disclosure.

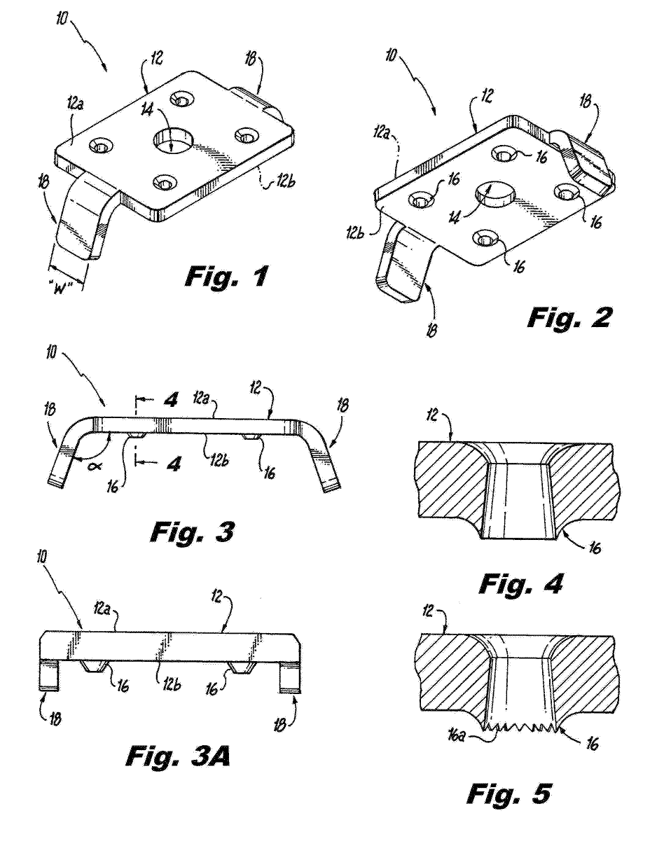

Referring to FIGS. 1-3, an exemplary embodiment of a bonding clamp according to the present disclosure is shown. In this exemplary embodiment, the bonding clamp 10 includes an electrically conductive body 12 having a top side 12a, a bottom side 12b, an aperture 14 for receiving a mounting fastener, and at least one electrical bonding member 16 extending from the bottom surface 12b of the body 12. The body 12 is made of a material that provides sufficient structural integrity to secure PV module frames to a rail system (described below) while also capable of conducting electricity to provide an electrical bond. As examples, the body 12 can be made of stainless steel or other conductive steel, aluminum and/or aluminum alloy.

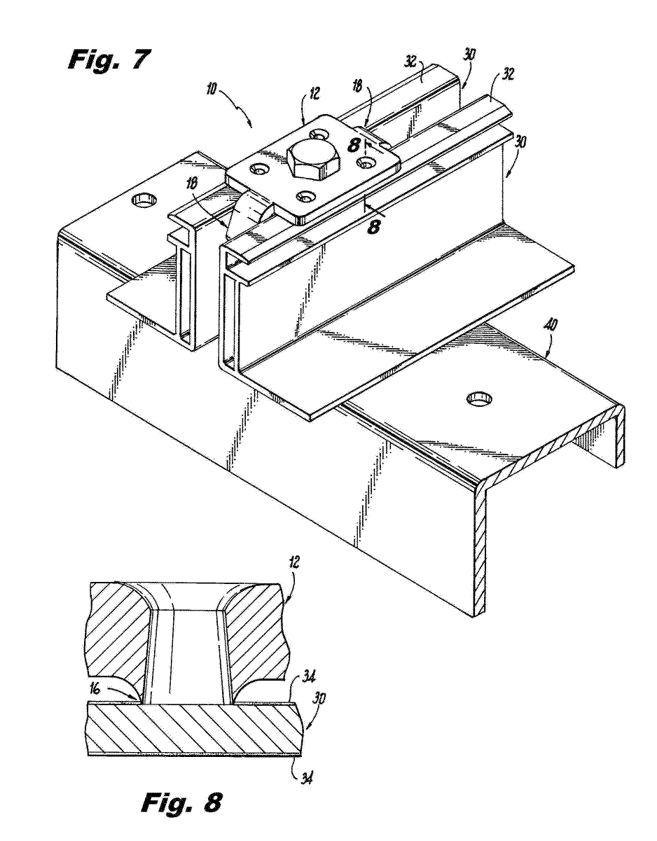

Extending from opposite ends of the body 12 are spacer members 18, e.g., spacer arms. The spacer arms 18 provide a substantially uniform spacing between PV modules frames when secured to a rail system, as will be described below, and also ensure that the bonding clamp 10 does not rotate when being secured to the rail system to ensure the electrical bonding. In one embodiment, the spacer arms 18 extend outward from the body 12, and have a bend which is in substantially the same direction as the electrical bonding members 16 extending from the bottom surface 12b of the body 12. The bend in the spacer arms 18 should be sufficient so that the spacer arm 18 falls between PV module frames, as seen in FIG. 7, when installed in a PV array. In one exemplary embodiment, seen in FIG. 3, the bend radius “α” of the spacer arm 18 may be in the range of about 30 degrees and about 90 degrees, but other bend radius' may be used. The spacer arms 18 can be integrally formed to the body 12, or the spacer arms can be secured to the body 12 by for example a welded joint. In another exemplary embodiment, seen in FIG. 3A, the spacer arms 18 may extend from the bottom surface 12b of the body 12 and substantially perpendicular to the bottom surface 12b of the body. The spacer arms 18 have a width “W” which can be in the range from about 0.25 inches to about 1.5 inches. However, one skilled in the art would readily appreciate that the width “W” can be any width that achieves the desired spacing between PV module frames. This width “W” sets the substantially uniform spacing between PV modules frames when secured to a rail system, as will be described below.

Referring to FIGS. 4 and 5, each electrical bonding member 16 forms a tooth or what is sometimes called in the industry a “volcano.” Each electrical bonding member is capable of cutting through or piercing non-conductive coatings on the PV module frames that protect the PV module frames from corrosion. Examples of such non-conductive coatings include oxide, paint and/or anodization. Each electrical bonding member 16 can be a unitary circular or other shaped tooth or structure, seen for example in FIG. 4, that is capable of cutting through or piercing the non-conductive coatings on the PV module frames. In another exemplary embodiment, each electrical bonding member 16 can be a unitary circular or other shaped tooth or structure having a serrated distal edge 16a, seen in FIG. 5, that is also capable of cutting through or piercing the non-conductive coatings on the PV module frames. The electrical bonding members 16 can be extruded from the body 12, or they can be secured to the body 12 by for example a welded joint.

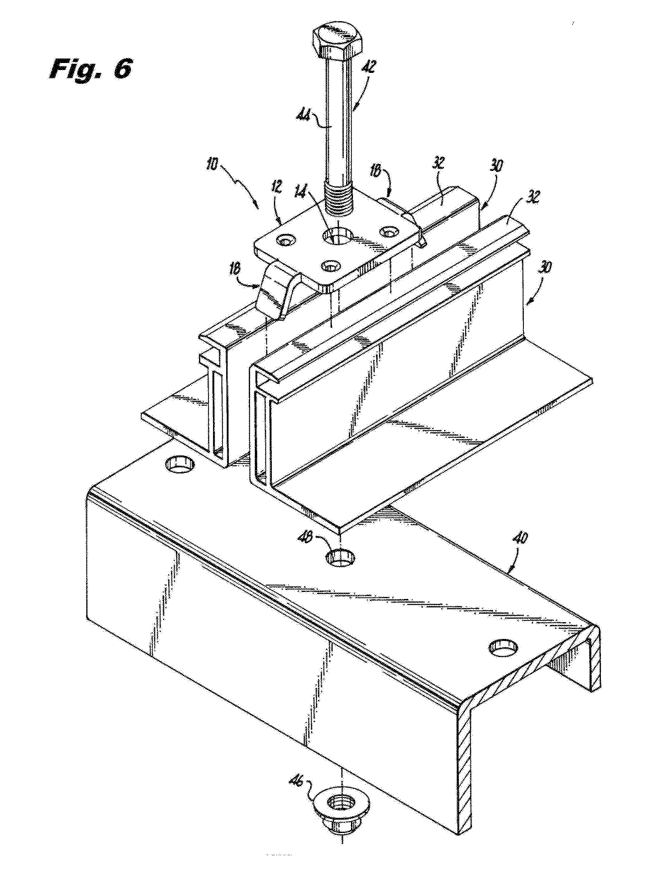

Turning to FIGS. 6-8, the bonding clamp 10 of the present disclosure will be described when connecting to PV module frames and a rail system. Referring to FIG. 6, portions of two PV module frames 30 are shown in a position to rest on a rail 40 of a rail system that supports a PV array. The bonding clamp 10 is positioned so that the body 12 can rest on a top surface 32 of each PV modules frames 30. In the embodiment shown, with the body 12 resting on the top surface 32 of the PV module frame 30, two electrical bonding members 16 are positioned to pierce the non-conductive coating on each PV module frame. However, one skilled in the art would readily recognize the only one electrical bonding member 16 may be positioned to pierce the non-conductive coating on each PV module frame 30, or that more than two electrical bonding members 16 can be positioned to pierce the non-conductive coating on each PV module frame. As noted above, the spacer arms 18 extending between the PV module frames 30 prevent the body 12 from shifting or rotating so that the one or more electrical bonding members 16 remain in a position to pierce the non-conductive coating 34 on the PV module frames. Further, with the body 12 resting on the PV module frames 30, the spacer arms 18 are positioned between the PV module frames 30 to provide the substantially uniform spacing “W” between the PV module frames 30, as seen in FIG. 7. The width “W” also defines an area along a length of the body 12 that does not contact the PV module frames 30 so that the body has two portions that contact the PV module frames such that the electrical bonding members 16 are positioned on the body in the two portions that contact the PV module frames.

To secure the PV module frames 30 to the rail 40, a mounting fastener 42, e.g., a nut and bolt, or rivets can be used. In this exemplary embodiment, a bolt 44 is passed through aperture 14 in the body 12 of the body clamp 10, between the PV module frames 30, and through aperture 48 in rail 40. A nut 46 is then attached to the bolt 44 and tightened to secure the bonding clamp 10 to the PV module frames 30, and the PV module frames 30 to the rail 40. As shown in FIG. 8, when the nut 46 and bolt 44 are tightened, each electrical bonding member 16 positioned over the top surface 32 of the PV module frame 30 cuts through or pierces the non-conductive coating 34 on the top surface 32 so that the conductive metal of the body 12 of the bonding clamp 10 is in electrical contact with the conductive metal of the PV module frame 30. As a result, an electrically conductive path is created between the two PV module frames 30, shown in FIG. 7, via the bonding clamp 10. When the rails and PV module frames are properly connected to electrical ground the electrically conductive path created by one or more bonding clamps 10 facilitates the bonding of the PV arrays.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A bonding clamp comprising:
an electrically conductive body having a top side, a bottom side, a fastener receiving member for receiving a mounting fastener, and at least one electrical bonding member extending from the bottom surface of the body;
a first spacer member extending from the electrically conductive body in a direction away from the bottom surface of the body; and
a second spacer member extending from the electrically conductive body in a direction away from the bottom surface of the body.

2. The bonding clamp according to claim 1, wherein the electrically conductive body is substantially planar.

3. The bonding clamp according to claim 1, wherein the first spacer member extends from one end of the electrically conductive body, and the second spacer member extends from an opposite end of the electrically conductive body.

4. The bonding clamp according to claim 1, wherein the first spacer member extends from the bottom surface of the electrically conductive body, and the second spacer member extends from the bottom surface of the electrically conductive body.

5. The bonding clamp according to claim 1, wherein the at least one electrical bonding member comprises a plurality of electrical bonding members.

6. The bonding clamp according to claim 5, wherein each of the plurality of electrical bonding members comprises a single tooth.

7. The bonding clamp according to claim 5, wherein each of the plurality of electrical bonding members comprises a single tooth having a serrated distal end.

8. The bonding clamp according to claim 1, wherein the at least one electrical bonding member comprises a single tooth.

9. The bonding clamp according to claim 1, wherein the at least one electrical bonding member comprises a single tooth having a serrated distal end.

10. The bonding clamp according to claim 1, wherein the fastener receiving member comprises an aperture.

11. A bonding clamp comprising:
an electrically conductive body having a top side and a bottom side;
a first spacer member extending from the electrically conductive body in a direction away from the bottom surface; and
a second spacer member extending from the electrically conductive body in a direction away from the bottom surface, the second spacer is aligned with the first spacer member such that the first and second spacers define two portions of the body that include at least one electrical bonding member extending from the bottom surface of the body.

12. The bonding clamp according to claim 11, wherein each of the two portions of the body that include at least one electrical bonding member include a plurality of electrical bonding members.

13. The bonding clamp according to claim 12, wherein each of the plurality of electrical bonding members comprises a single tooth.

14. The bonding clamp according to claim 12, wherein each of the plurality of electrical bonding members comprises a single tooth having a serrated distal end.

15. The bonding clamp according to claim 11, wherein the at least one electrical bonding member in each portion of the two portions comprises a single tooth.

16. The bonding clamp according to claim 11, wherein the at least one electrical bonding member in each portion of the two portions comprises a single tooth and each tooth has a serrated distal end.

17. The bonding clamp according to claim 11, wherein the first spacer member extends from one end of the electrically conductive body, and the second spacer member extends from an opposite end of the electrically conductive body.

18. The bonding clamp according to claim 11, wherein the first spacer member extends from the bottom surface of the electrically conductive body, and the second spacer member extends from the bottom surface of the electrically conductive body.

19. The bonding clamp according to claim 11, wherein the electrically conductive body is substantially planar.

20. A bonding clamp comprising:
an electrically conductive body having a top side, a bottom side, a hole for receiving a mounting fastener, and a plurality of electrical bonding members extending from the bottom surface of the body;
a first spacer member extending from the electrically conductive body in a direction away from the bottom surface of the body; and
a second spacer member extending from the electrically conductive body in a direction away from the bottom surface of the body.

21. The bonding clamp according to claim 20, wherein the electrically conductive body is substantially planar.

22. The bonding clamp according to claim 20, wherein the first spacer member extends from one end of the electrically conductive body, and the second spacer member extends from an opposite end of the electrically conductive body.

23. The bonding clamp according to claim 20, wherein the first spacer member extends from the bottom surface of the electrically conductive body, and the second spacer member extends from the bottom surface of the electrically conductive body.

24. The bonding clamp according to claim 20, wherein each of the plurality of electrical bonding members comprises a single tooth.

25. The bonding clamp according to claim 20, wherein each of the plurality of electrical bonding members comprises a single tooth having a serrated distal end.
